(19) United States
(12) Patent Application Publication
(10) Pub. No.: US 2024/0340189 A1
(43) Pub. Date: Oct. 10, 2024

(54) INFORMATION PROCESSING APPARATUS, NODE SELECTION METHOD, AND PROGRAM

(71) Applicant: NIPPON TELEGRAPH AND TELEPHONE CORPORATION, Tokyo (JP)

(72) Inventors: Hiroshi MATSUURA, Tokyo (JP); Yoshinori GOTO, Tokyo (JP); Hidehiro SAO, Tokyo (JP)

(73) Assignee: NIPPON TELEGRAPH AND TELEPHONE CORPORATION, Tokyo (JP)

(21) Appl. No.: 18/294,104

(22) PCT Filed: Aug. 2, 2021
(86) PCT No.: PCT/JP2021/028624

§ 371 Date: Jan. 31, 2024

(51) Int. Cl. H04L 9/00

(52) U.S. Cl. CPC H04L 9/50

(57) ABSTRACT

An object is to efficiently improve fairness between nodes in a blockchain network.

The information processing device as the node 3 of the present invention receives a request for adding an Inbound adjacent node from a predetermined requestor node, and does not select the requestor node 2b as an Inbound adjacent node in a case where a region to which the predetermined requestor node belongs is different from the specific region A3 to which the information processing device belongs and the predetermined value n11 of nodes belonging to a region different from the specific region A3 that can be selected as Inbound adjacent nodes has been reached. This produces an effect that it is possible to efficiently improve fairness between nodes in the blockchain network 1.

### TECHNICAL FIELD

The present disclosure relates to an information processing device, a node selection method, and a program.

### BACKGROUND ART

A blockchain is a database that preserves data by generating a unit of encrypted data called a block and concatenating blocks like a chain. Blockchain technology is widely used as a platform of virtual currency represented by bitcoin.

Each node belonging to a blockchain network serves as a miner and generates a new block satisfying a hash function condition. A node that generates a block approved from a certain number of nodes can obtain a reward. However, in a case where a plurality of different miners generate blocks satisfying the hash function condition at substantially the same time, a plurality of blocks may be simultaneously approved and the blockchain may be branched (fork). In this case, a block belonging to a branch destination chain other than a chain having the largest number of blocks needs to be discarded later as an orphan block. One of the causes of the forking is a block transmission time, which is the time until a block spreads throughout the network. This is because if the block transmission time is sufficiently short, a block generated later is not approved.

Each node of the blockchain network holds eight adjacent nodes as Outbound adjacent nodes as default, and directly transmits a block generated by its own node or a block transferred from another node to the Outbound adjacent nodes. Moreover, each node holds Inbound adjacent nodes in addition to the Outbound adjacent nodes. An Inbound adjacent node of a certain node is an adjacent node from which the certain node can directly receive a block. Each node can hold up to 125 Outbound and Inbound adjacent nodes in total.

A certain node has two tables, and selects Outbound adjacent nodes from the two tables. The first table is a new table in which nodes that have held no adjacency relationship with the certain node are listed, and information obtained from a domain name system (DNS) is initially stored in the new table. The second table is a tried table in which nodes that have had an adjacency relationship with the certain node are listed.

Although eight Outbound adjacent nodes are initially set as default in each node of the blockchain network, the adjacent nodes may be periodically changed in accordance with addition of a new node, down of an adjacent node, or the like. Although the source code of a bitcoin node that is a representative blockchain network can be downloaded from the URL “bitcoin/bitcoin: https://github.com/bitcoin/bitcoin”, each node randomly selects eight Outbound adjacent nodes from the new table and the tried table held by the certain node in default setting. Moreover, in a case where a request for adding an Inbound adjacent node from another node is made, the node is randomly stored in the Inbound adjacent node list as long as the total number of adjacent nodes does not exceed 125 (Method 1).

Non Patent Literature 1 focuses on the fact that there is a high possibility that a non-regional adjacent node having a large propagation delay is selected in a case where the above-described Method 1 is to randomly select an OutBound adjacent node, and proposes to suppress the number of non-regional adjacent nodes among the OutBound adjacent nodes to one or two or less (Method 2).

However, similarly to the Method 1, there is no restriction on the number of non-regional adjacent nodes in the method of selecting an Inbound adjacent node in each node in the Method 2, and when a request for adding an Inbound adjacent node is received from a certain node, the request is received in a case where the upper limit of the number of Inbound adjacent nodes for each node has not been reached. For example, in a case where the upper limit of the number of Inbound adjacent nodes is set to 30 and only 29 adjacent nodes are set in the Inbound adjacent node list when a specific node receives a request for adding an adjacent node from a requestor node, the requestor node is added as the Inbound adjacent node list of the specific node.

In the Method 2, since the upper limit of the number of non-regional Outbound adjacent nodes of each node is set to 1 or 2, inter-region communication until one block spreads throughout nodes belonging to each region in the whole world is reduced, and as a result, the block transmission time until one block spreads throughout the nodes is shortened as compared with the Method 1.

### CITATION LIST

### Non Patent Literature

Non Patent Literature 1: Hiroshi Matsuura, Yoshinori Goto, Hidehiro Sao, “Proximity Neighbor Selection in a Blockchain Network”, IEICE General Conference B-6-30, 2021.

### SUMMARY OF INVENTION

### Technical Problem

However, the above-described Method 2 has the following problems.

A first problem is that there is a possibility that there arises a difference in the number of Inbound adjacent nodes of nodes and a node having a smaller number of Inbound adjacent nodes has a delayed reception time of block data as compared with a node having a larger number of Inbound adjacent nodes or cannot receive block data within a set time. A node in which reception of block data is delayed may have a delayed start time for mining a next block, and a node in which block data cannot be received will miss a mining opportunity. That is, there arises unfairness between miners.

A second problem is that there arises a difference in the number or ratio of non-regional adjacent nodes among the Inbound adjacent nodes between nodes. A node having many non-regional adjacent nodes may receive block data from the outside of the region early, but may receive block data from the inside of the region late. As described above, a variation in time for receiving block data between nodes may become large.

The present invention has been made in view of the above points, and an object thereof is to efficiently improve fairness between nodes in a blockchain network.

### Solution to Problem

In order to solve the above problems, an invention according to claim 1 is an information processing device as a predetermined node among a plurality of nodes constituting a blockchain network extending over a plurality of regions, the information processing device including: selection means capable of making a selection of a requestor node that has made a request for adding an Inbound adjacent node as an Inbound adjacent node; and reception means configured to receive the request for adding an Inbound adjacent node from a predetermined requestor node, in which the selection means does not make the selection in a case where a region to which the predetermined requestor node belongs is different from a specific region to which the information processing device belongs and a predetermined value of nodes belonging to a region different from the specific region that can be selected as Inbound adjacent nodes has been reached.

Moreover, an invention according to claim 6 is an information processing device as a predetermined node among a plurality of nodes constituting a blockchain network extending over a plurality of regions, the information processing device including: selection means capable of making a selection of a requestor node that has made a request for adding an Inbound adjacent node as an Inbound adjacent node; and reception means configured to receive the request for adding an Inbound adjacent node from a predetermined requestor node, in which the selection means does not make the selection in a case where a region to which the predetermined requestor node belongs is different from a specific region to which the information processing device belongs and a ratio of nodes belonging to a region different from the specific region that can be selected as Inbound adjacent nodes at an upper limit value selectable as Inbound adjacent nodes has reached a predetermined value.

### Advantageous Effects of Invention

As described above, the present invention produces an effect that it is possible to efficiently improve fairness between nodes in a blockchain network.

### BRIEF DESCRIPTION OF DRAWINGS

FIG. 1 is a schematic diagram of a blockchain network.

FIG. 2 is an electrical hardware configuration diagram of a node.

FIG. 3 is a functional configuration diagram of a node.

FIG. 4 is a flowchart illustrating a method of selecting an Outbound adjacent node.

FIG. 5 is a flowchart illustrating a method of selecting an Inbound adjacent node.

FIG. 6 is a diagram illustrating a matrix of propagation delays (milliseconds) in data transfer to the inside and the outside of a region in SimBlock setting.

FIG. 7 is a graph illustrating a shortening effect of a transmission time of block data in each method.

### DESCRIPTION OF EMBODIMENTS

Hereinafter, an embodiment of the present invention will be described with reference to the drawings.

### [Outline of Blockchain Network]

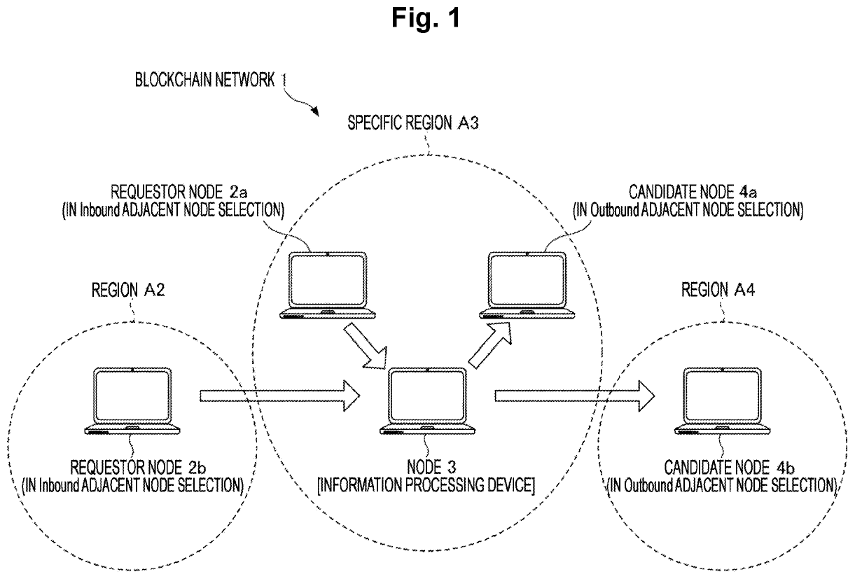

First, an outline of a blockchain network of the present embodiment will be described with reference to FIG. 1. FIG. 1 is a schematic diagram of a blockchain network. Note that FIG. 1 illustrates a simplified blockchain network, in which only five nodes are illustrated because of space limitations. Moreover, only three regions are shown for similar reason.

As illustrated in FIG. 1, a blockchain network 1 of the present embodiment is constructed with a node 2a, a node 2b, a node 3, a node 4a, and a node 4b. The blockchain network 1 is constructed in a communication network such as the Internet.

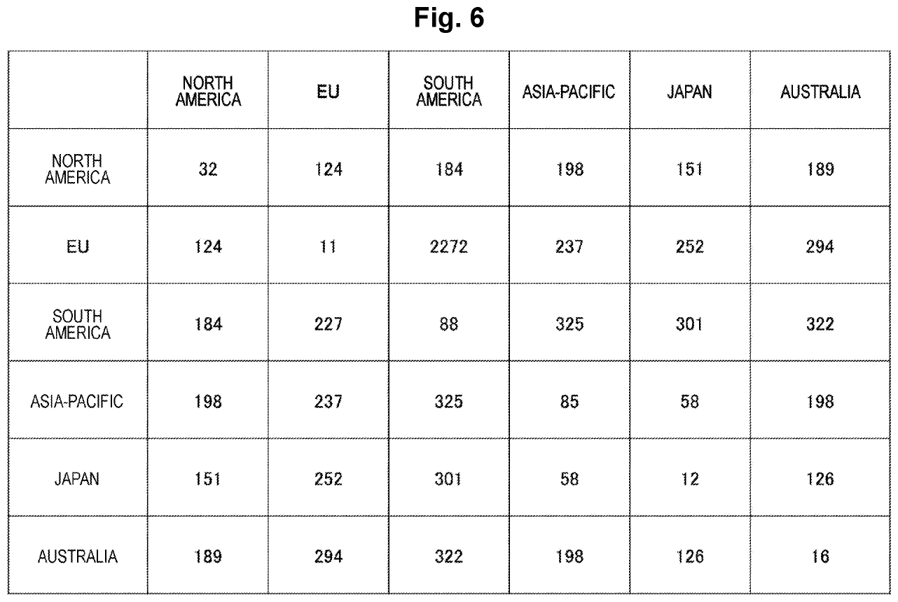

Each node is a computer. FIG. 1 illustrates a notebook personal computer as an example of a computer. In FIG. 1, the nodes 2a, 3, and 4a belong to the same region (specific region A3). Each region is a region illustrated in FIG. 6 to be described later. The node 2b belongs to a region A2 different from the specific region A3. The node 4b belongs to a region A4 different from the specific region A3. Note that the region A2 and the region A4 may be the same region.

Any of the nodes can make a request for adding an Inbound adjacent node, select an Inbound adjacent node, and select an Outbound adjacent node. In FIG. 1, the nodes 2a and 2b are illustrated as requestor nodes that request the node 3 to select an Inbound adjacent node. Moreover, the nodes 4a and 4b are illustrated as possible nodes to be selected by the node 3 as an Outbound adjacent node. Note that, although all the nodes are information processing devices, the node 3 is indicated as an information processing device in FIG. 1 in order to distinguish the node 3 from the other nodes 2a, 2b, 4a, and 4b.

### [Hardware Configuration of Node]

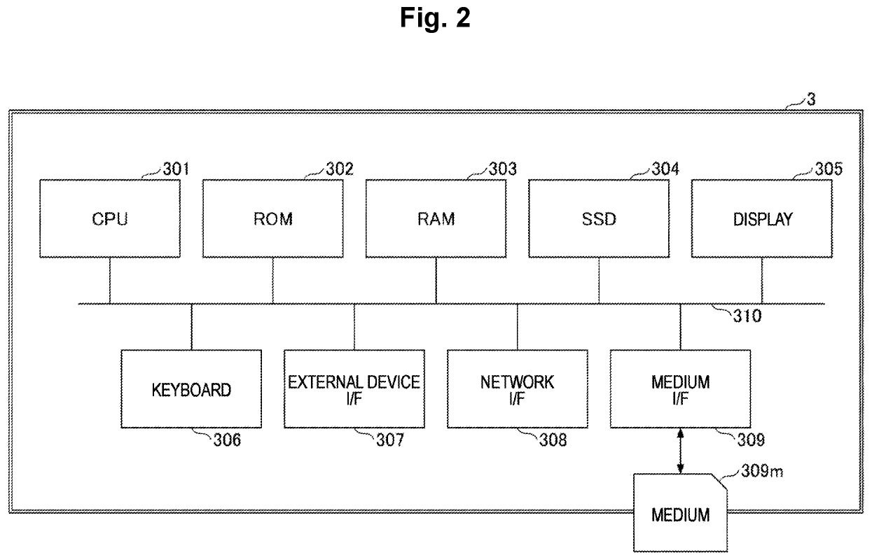

Next, an electrical hardware configuration of the node 3 will be described with reference to FIG. 2. FIG. 2 is an electrical hardware configuration diagram of a node.

As illustrated in FIG. 2, the node 3 includes, as a computer, a central processing unit (CPU) 301, a read only memory (ROM) 302, a random access memory (RAM) 303, a solid state drive (SSD) 304, a display 305, a keyboard 306, an external device I/F 307, a network I/F 308, a medium I/F 309, and a bus line 310.

Among them, the CPU 301 controls the operation of the entire node 3. The ROM 302 stores a program used for driving the CPU 301, such as an initial program loader (IPL). The RAM 303 is used as a work area of the CPU 301.

The SSD 304 is a storage device that reads or writes various data such as a program of a node under the control of the CPU 301. Note that a storage device such as a hard disk drive (HDD) may be used instead of the SSD.

The display 305 is a type of display means such as liquid crystal or organic electro luminescence (EL) that displays characters, images, and the like.

The keyboard 306 is a type of input means including a plurality of keys for inputting characters, numerical values, various instructions, and the like.

The external device I/F 307 is an interface to be connected with various external devices. Examples of the external device in this case include an external display as an example of display means, a mouse, an external keyboard, or a microphone as an example of input means, a printer or a speaker as an example of output means, and a universal serial bus (USB) memory as an example of storage means.

The network I/F 308 is a circuit for transmitting and receiving data and the like to and from other nodes via the Internet.

The medium I/F 309 controls reading or writing (storing) of data with respect to a recording medium 309m such as a flash memory. Examples of the recording medium 309m also include a digital versatile disc (DVD), a Blu-ray Disc (registered trademark), and the like.

The bus line 310 is an address bus, a data bus, or the like for electrically connecting the respective components such as the CPU 301 illustrated in FIG. 2.

Since the other nodes 2a, 2b, 4a, and 4b have configurations similar to the node 3, the description thereof will be omitted.

### [Functional Configuration of Node]

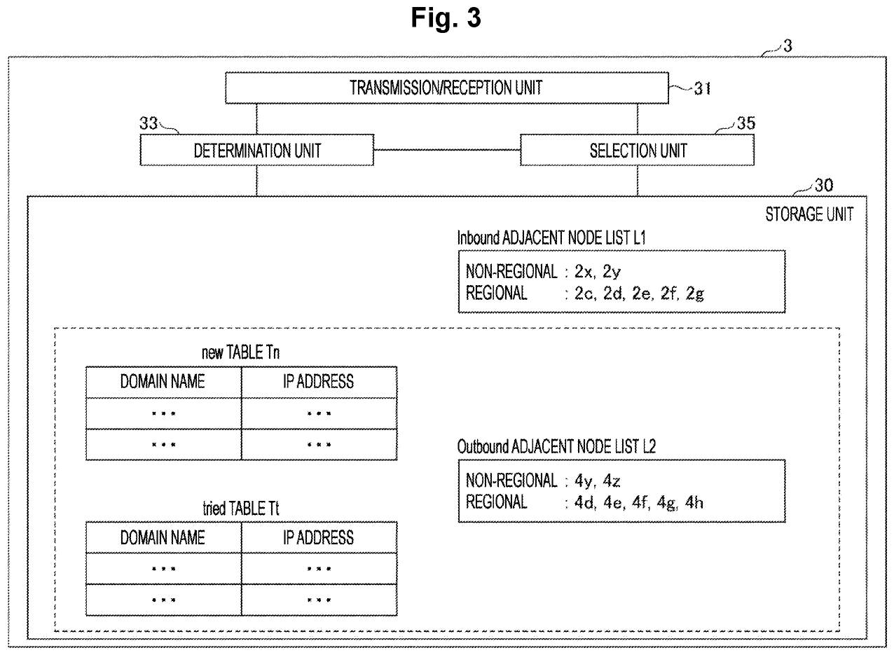

Next, a functional configuration of a node will be described with reference to FIG. 3. FIG. 3 is a functional configuration diagram of a node in the embodiment of the present invention.

In FIG. 3, the node 3 includes a transmission/reception unit 31, a determination unit 33, and a selection unit 35. Each of these units is a function implemented by a command by the CPU 301 in FIG. 2 on the basis of a program.

Moreover, the node 3 includes a storage unit 30 constructed with at least one of the RAM 303 or the SSD 304 in FIG. 2.

### <Stored Data>

The storage unit 30 stores an Inbound adjacent node list L1, a new table Tn, a tried table Tt, and an Outbound adjacent node list L2.

The Inbound adjacent node list L1 shows information indicating the latest node selected as an Inbound adjacent node for each of the outside of the specific region A3 and the inside of the specific region A3. Here, the upper limit value selectable as Inbound adjacent nodes is 8. Moreover, a predetermined value n11 of nodes in a region outside the specific region A3 that can be selected as Inbound adjacent nodes is 2 here. A predetermined value n12 of nodes in a region inside the specific region A3 that can be selected as Inbound adjacent nodes is 6. Note that the predetermined value n11 is preferably smaller than an average value of the number of nodes belonging to a region different from the specific region A3 to be selected when the selection unit 35 randomly selects an Inbound adjacent node.

In the new table, a list of information including a domain name, an IP address, and the like of a node that has not held an adjacency relationship with the node 3 connected with the blockchain network 1 is registered. Initially, information obtained from a domain name system (DNS) is registered in the new table. Note that the adjacency relationship refers to a relationship in which direct exchange (transmission and reception) of block data is permitted.

In the tried table, a list of information including a domain name, an IP address, and the like of a node that has had an adjacency relationship with the node 3 is registered.

The Outbound adjacent node list L2 shows information indicating the latest node selected as an Outbound adjacent node for each of the outside of the specific region A3 and the inside of the specific region A3. Here, the upper limit value selectable as the Outbound adjacent node is the same (e.g., 8) as the upper limit value selectable as the Inbound adjacent node. Moreover, the predetermined value of nodes in a region outside the specific region A3 that can be selected as Outbound adjacent nodes is n11 (e.g., 2), which is the same as the predetermined value of nodes in a region outside the specific region A3 that can be selected as Inbound adjacent nodes. The predetermined value of nodes in a region inside the specific region A3 that can be selected as Outbound adjacent nodes is n12 (e.g., 6), which is the same as the predetermined value of nodes in a region inside the specific region A3 that can be selected as Inbound adjacent nodes. As described above, when the upper limit value, the predetermined value n11, and the predetermined value n12 are unified between the case of selection of Inbound adjacent nodes and the case of selection of Outbound adjacent nodes, it is possible to further efficiently improve the fairness between nodes in the blockchain network 1.

### <Each Functional Configuration>

Next, each functional configuration of a node will be described.

The transmission/reception unit 31 is mainly implemented by processing of the CPU 301 with respect to the network I/F 307, and transmits and receives various data (or information) to and from other devices (e.g., nodes) via a communication network.

The determination unit 33 is implemented by processing of the CPU 301, and makes various determinations. For example, the determination unit 33 determines whether a region to which the requestor node belongs is different from the specific region A3 to which the node 3 belongs or not on the basis of the IP address of the requestor node that has made a request for adding an Inbound adjacent node.

The selection unit 35 is implemented by processing of the CPU 301, and selects an Inbound adjacent node or an Outbound adjacent node. At this time, the selection unit 35 determines whether the predetermined value n11 of nodes belonging to a region different from the specific region A3 that can be selected as Inbound adjacent nodes or Outbound adjacent nodes has been reached or not. Moreover, the selection unit 35 determines whether the predetermined value n12 of nodes belonging to the same region as the specific region A3 that can be selected as Inbound adjacent nodes or Outbound adjacent nodes has been reached or not.

Note that the selection unit 35 may determine whether a ratio of nodes belonging to a region different from the specific region A3 that can be selected as Inbound adjacent nodes (or Outbound adjacent nodes) at the upper limit value selectable as Inbound adjacent nodes (or Outbound adjacent nodes) has reached a predetermined value n21 or not. Moreover, the selection unit 35 may determine whether a ratio of nodes belonging to the same region as the specific region A3 that can be selected as Inbound adjacent nodes (or Outbound adjacent nodes) at the upper limit value selectable as Inbound adjacent nodes (or Outbound adjacent nodes) has reached a predetermined value n22 or not.

### [Processing or Operation of Embodiment]

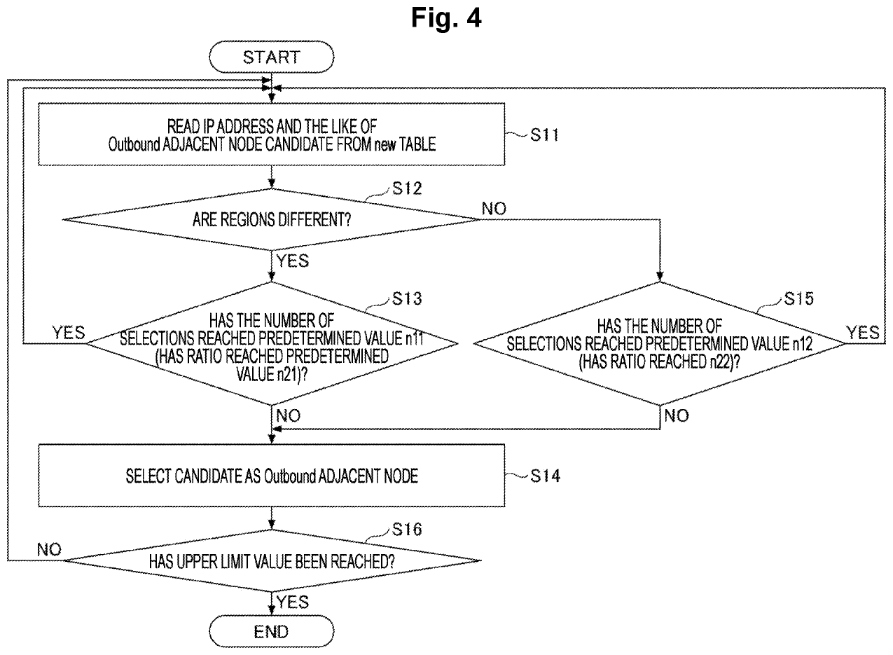

Next, processing or operation of the present embodiment will be described in detail with reference to FIGS. 4 to 7.

### <Selection of Outbound Adjacent Node>

The Outbound adjacent node selection processing will be described with reference to FIG. 4. FIG. 4 is a flowchart illustrating Outbound adjacent node selection processing. Note that the Outbound adjacent node selection processing described below is content that illustrates the above-described Method 2 in detail.

First, the determination unit 33 initially reads the domain name and the IP address of a possible node for the Outbound adjacent node from the new table Tn (S11).

Next, the determination unit 33 determines whether a region to which the possible node belongs is different from the specific region A3 to which the node 3 belongs or not on the basis of the domain name and the IP address (S12). The IP address is managed by a world organization called Internet Corporation Assigned Names and Numbers (ICANN) (“What Does ICANN Do?: https://www.icann.org/resources/pages/what-2012-02-25-ja”). The determination unit 33 of the node 3 may determine whether the node of the IP address registered in the DNS is in the specific region A3 (own region) or another region by using the public information.

Then, for example, in a case where the belonging regions are different as the case of the possible node 4b (S12; YES), the selection unit 35 determines whether the predetermined value n11 of nodes belonging to a region different from the specific region A3 that can be selected as Outbound adjacent nodes has been reached or not (S13). Specifically, the selection unit 35 determines whether the number of selected Outbound adjacent nodes belonging to the outside of the specific region A3 has reached the predetermined value n11 (e.g., 2) in the Outbound adjacent node list L2 or not. In a case where the predetermined value n11 has not been reached (S13; NO), the selection unit 35 selects the possible node as an Outbound adjacent node (S14). On the other hand, in a case where the predetermined value n11 has been reached in step S13 (S13; YES), the process returns to step S11.

For example, in the case of FIG. 3, since two (4y, 4z) nodes outside the specific region A3 have already been selected, the predetermined value n11 has been reached. Therefore, the selection unit 35 does not select the possible node 4b in FIG. 1 as an Outbound adjacent node.

Note that, in step S13, the selection unit 35 may determine whether a ratio of nodes belonging to a region different from the specific region A3 that can be selected as Outbound adjacent nodes at the upper limit value selectable as Outbound adjacent nodes has reached the predetermined value n21 (e.g., 25%) or not.

Moreover, in a case where there is no difference (the same) in step S12 described above (S12; NO), the selection unit 35 determines whether the predetermined value n12 of nodes belonging to the same region as the specific region A3 that can be selected as Outbound adjacent nodes has been reached or not (S15). Specifically, the selection unit 35 determines whether the number of selected Outbound adjacent nodes belonging to the inside of the specific region A3 has reached the predetermined value n12 (e.g., 6) in the Outbound adjacent node list L2 or not. Then, in a case where the predetermined value n12 has not been reached (S15; NO), the selection unit 35 selects the possible node as an Outbound adjacent node in step S14. On the other hand, in a case where the predetermined value n12 has been reached in step S15 (S15; YES), the process returns to step S11.

For example, in the case of FIG. 3, only five regional nodes (4d, 4e, 4f, 4g, 4h) have been selected, and thus, the predetermined value n12 has not been reached. Therefore, the selection unit 35 selects the possible node 4a as an Outbound adjacent node.

Note that, in step S15, the selection unit 35 may determine whether a ratio of nodes belonging to the same region as the specific region A3 that can be selected as Outbound adjacent nodes at the upper limit value selectable as Outbound adjacent nodes has reached the predetermined value n22 (e.g., 75%) or not.

Next, after step S14, the selection unit 35 determines whether an upper limit value (e.g., 8) selectable as Outbound adjacent nodes has been reached or not (S16). Then, in a case where the upper limit value has not been reached (S16; NO), the process returns to step S11. Moreover, in a case where the upper limit value has been reached (S16; YES), the Outbound adjacent node selection processing in FIG. 4 ends.

Through the above processing, the number of non-regional Outbound adjacent nodes can be always suppressed to, for example, two or less in each node.

### <Selection of Inbound Adjacent Node>

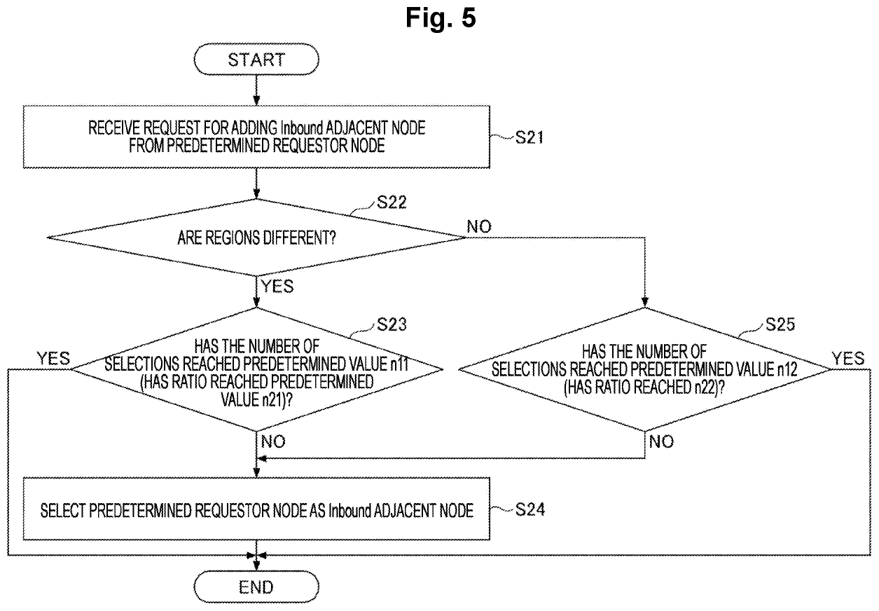

The Inbound adjacent node selection processing will be described with reference to FIG. 5. FIG. 5 is a flowchart illustrating Inbound adjacent node selection processing. Note that the Inbound adjacent node selection processing described below is content that illustrates Method 3 in detail.

First, the transmission/reception unit 31 of the node 3 receives a request for adding an Inbound adjacent node from a predetermined requestor node (S21). In FIG. 1, the transmission/reception unit 31 of the node 3 receives the request from the node 2a or the node 2b. At this time, the transmission/reception unit 31 also receives the IP address of the requestor node. Note that the IP address is an example of identification information for identifying the requestor node on the Internet.

Next, the determination unit 33 determines whether a region to which the requestor node belongs is different from the specific region A3 to which the node 3 belongs or not on the basis of the IP address received in step S21 (S22). For example, the determination unit 33 can determine whether a region to which the requestor node belongs is different from the specific region 3A (own region) or not by using the ICANN public information. Then, in a case where there is a difference (S22; YES), the selection unit 35 determines whether the predetermined value n11 of nodes belonging to a region different from the specific region A3 that can be selected as Inbound adjacent nodes has been reached or not (S23). Specifically, the selection unit 35 determines whether the number of selected Inbound adjacent nodes belonging to the outside of the specific region A3 has reached the predetermined value n11 in the Inbound adjacent node list L1 or not. Then, in a case where the predetermined value n11 has not been reached (S23; NO), the selection unit 35 selects the requestor node as an Inbound adjacent node (S24). On the other hand, in a case where the predetermined value n11 has been reached in step S23 (S23; YES), the Inbound adjacent node selection processing in FIG. 5 ends.

For example, in the case of FIG. 3, since two non-regional nodes (2x, 2y) have already been selected, the predetermined value n11 has been reached. Therefore, the selection unit 35 does not select the requestor node 2b as an Inbound adjacent node.

Note that, in step S23, the selection unit 35 may determine whether a ratio of nodes belonging to a region different from the specific region A3 that can be selected as Inbound adjacent nodes at the upper limit value selectable as Inbound adjacent nodes has reached the predetermined value n21 (e.g., 25%) or not.

Moreover, in a case where there is no difference (the same) in step S22 described above (S22; NO), the selection unit 35 determines whether the predetermined value n12 of nodes belonging to the same region as the specific region A3 that can be selected as Inbound adjacent nodes has been reached or not (S25). Specifically, the selection unit 35 determines whether the number of selected Inbound adjacent nodes belonging to the inside of the specific region A3 has reached the predetermined value n12 in the Inbound adjacent node list L1 or not. Then, in a case where the predetermined value n12 has not been reached (S25; NO), the selection unit 35 selects the requestor node as an Inbound adjacent node in step S24. On the other hand, in a case where the predetermined value n12 has been reached in step S25 (S25; YES), the Inbound adjacent node selection processing in FIG. 5 ends.

For example, in the case of FIG. 3, since only five nodes (2c, 2d, 2e, 2f, 2g) inside the specific region A3 have been selected, the predetermined value n12 has not been reached. Therefore, the selection unit 35 selects the requestor node 2a as an Inbound adjacent node.

Note that, in step S25, the selection unit 35 may determine whether a ratio of nodes belonging to the same region as the specific region A3 that can be selected as Inbound adjacent nodes at the upper limit value selectable as Inbound adjacent nodes has reached the predetermined value n22 (e.g., 75%) or not.

Through the above processing, the number of non-regional Inbound adjacent nodes can be always suppressed to, for example, two or less in each node.

### [Comparative Evaluation of Methods]

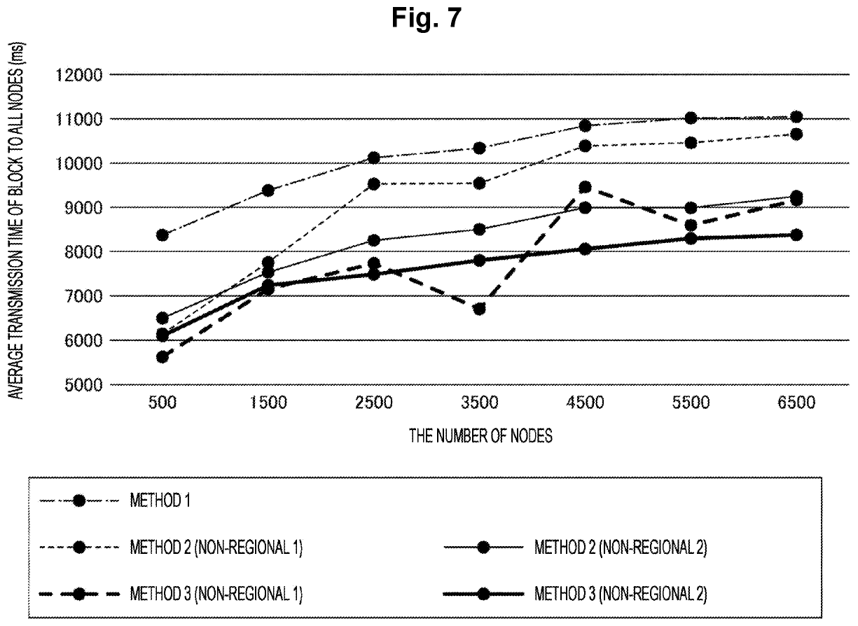

Next, comparative evaluations of Methods 1, 2, and 3 will be described with reference to FIGS. 6 and 7. FIG. 6 is a diagram illustrating a matrix of propagation delays (milliseconds) in data transfer to the inside and the outside of a region in SimBlock setting. This matrix is based on statistical information of the bitcoin network in 2019.

The following shows a quantitative comparative evaluation of Method 1, Method 2, and Method 3. As a simulator, SimBlock of “Tokyo Tech News: SimBlock: A simulator for testing improvements to real-world blockchain networks: https://www.titech.ac.jp/news/2019/044557.html” was used.

In SimBlock, nodes can be randomly arranged in each of six regions of the world as illustrated in FIG. 6 to set adjacency relationships between nodes. In the evaluation environment used in this comparative evaluation, the arrangement ratio of nodes of the bitcoin in 2019 was used to randomly arrange nodes in regions of the world with the arrangement possibility of North America (33.16%), EU (49.98%), South America (0.9%), Asia-Pacific (11.77%), Japan (2.24%), and Australia (1.95%).

FIG. 7 is a graph illustrating a shortening effect of the transmission time of block data in each method.

The “Method 1” is a method of randomly selecting eight Outbound adjacent nodes. The “Method 2” is a method of fixing the number of adjacent nodes outside the specific region A3 among the Outbound adjacent nodes to 1 or 2 or less. However, in both the Method 1 and the Method 2, the upper limit of the number of Inbound adjacent nodes is set to 30, and each node accepts a request for adding an Inbound adjacent node if the number is equal to or smaller than 30. In the Method 3, the upper limit value of the Inbound adjacent nodes is set to 8, which is the same as the upper limit value of the Outbound adjacent nodes, and a predetermined value that is the upper limit of the number of adjacent nodes outside the specific region A3 among the Inbound adjacent nodes is set to be the same as a predetermined value that is the upper limit of the number of adjacent nodes outside the specific region A3 among the Outbound adjacent nodes. That is, the “Method 3 (non-regional 1)” in FIG. 7 means that a predetermined value, which is the upper limit of the number of adjacent nodes outside the specific region A3, is 1 for both Outbound and Inbound.

Since the block height of the main chain was set to 200 as a condition for evaluation, evaluation was continued until blocks of 201 main chains spread throughout the blockchain network 1. Note that the average transmission time of block data indicates an average value of time from generation of a block of each main chain to spread throughout the nodes on the blockchain network 1. However, if certain block data in the main chain does not spread throughout the nodes before forking or in a preset time (bitcoin=10 minutes), the transmission time of this block is not included in the average value.

Here, the forking will be described in detail. In the blockchain network 1, in a case where different blocks are generated by different miners at substantially the same time, a specified number of approval may be obtained for both blocks, and the blocks may fork and be generated under the same parent block (“Wikipedia: Blockchain: https://ja.wikipedia.org/wiki/% E3%83%96%E3%83%AD%E3%83%83%E 3%82%AF%E3%83%81%E3%82%A7%E3%83%BC %E3%83%B3” (which will be hereinafter, referred to as “reference literature”)). In this case, since a block that has not become a main chain after forking is discarded as an orphan block (reference literature), and a transaction performed on the orphan block is also discarded, the orphan block should not be generated as much as possible. One factor of generation of an orphan block is the transmission time of block data. This is because, if the block data spreads throughout the blockchain network 1 at a high speed, the block data has already arrived at a certain node when a notification of generation of other block data arrives at this node, and thus the block data arriving later is not approved.

Furthermore, the proof of work (POW) was used in the evaluation as a blockchain consensus algorithm (“BLOCKCHAIN business community: Blockchain wo sasaeru gijutsu “Proof of Work (POW)” towa (What is “Proof of Work (POW)”, the technology for supporting blockchain?): https://www.businessblockchain.org/what-is-proof-of-work-for-blockchain/”).

The Method 2 can greatly shorten the average transmission time of block data of the Method 1 when the number of Inbound adjacent nodes outside the specific region A3 is 1 or 2. However, the Method 3 (non-regional 1) could further greatly (average 14.8%) shorten the average transmission time of the Method 2 (non-regional 1) in all blockchain networks 1. Moreover, the Method 3 (non-regional 2) could further (average 7.8%) shorten the average transmission time of the Method 2 (non-regional 2) in all blockchain networks 1.

### Main Effects of Embodiment

As described above, according to the present embodiment, the node 3 does not select a predetermined requestor node as an Inbound adjacent node (S24) in a case where a region to which the predetermined requestor node belongs is different from the specific region A3 to which the node 3 belongs (S22; YES) and the predetermined value n11 of nodes belonging to a region different from the specific region A3 that can be selected as Inbound adjacent nodes has been reached (S23; YES). This produces an effect that it is possible to efficiently improve fairness between nodes in the blockchain network 1.

In particular, the upper limit value selectable as Inbound adjacent nodes and Outbound adjacent nodes, the predetermined value n11 (n21), and the predetermined value n12 (n22) are unified between the case of selection of Inbound adjacent nodes and the case of selection of Outbound adjacent nodes, so that an effect is obtained that the fairness between nodes in the blockchain network 1 can be further efficiently improved.

### [Supplement]

Although an embodiment of the present invention has been described in detail above, the present invention is not limited to such a specific embodiment, and various modifications and changes can be made as follows within the scope of the gist of the present invention described in the claims.

(1) Although the node 3 can be implemented by a computer and a program, the program can also be recorded in a recording medium or provided via a communication network.

(2) Although a notebook personal computer is illustrated as an example of the node in the above embodiment, the node is not limited thereto and may be, for example, a desktop personal computer, a tablet terminal, a smartphone, or the like.

(3) Each CPU 301 may be not only a single CPU or may be a plurality of CPUs.

### REFERENCE SIGNS LIST

1 Blockchain network
2a Requestor node (belonging to specific region A3)
2b Requestor node (belonging to region A2)
3 Node (example of information processing device)
4a Possible node (belonging to specific region A3)
4b Possible node (belonging to specific region A4)
30 Storage unit
31 Transmission/reception unit (example of reception means, example of transmission means)
33 Determination unit (example of determination means)
35 Selection unit (example of selection means)

1. An information processing device comprising a processor configured to execute operations comprising:
except when a region to which a predetermined requestor node belongs is distinct from a predetermined region to which the predetermined node belongs and a predetermined value of nodes belonging to the region is different from the predetermined region that is selectable as Inbound adjacent nodes has been reached:
selecting, by the predetermined node among a plurality of nodes of a blockchain network, a requestor node that has made a request for adding an Inbound adjacent node as an Inbound adjacent node, wherein the blockchain network extends over a plurality of regions; and
receiving, by the predetermined node, the request for adding an Inbound adjacent node from a predetermined requestor node.

2. The information processing device according to claim 1, wherein
the receiving further comprises receiving identification information, wherein the identification information identifies for identifying the predetermined requestor node on Internet from the predetermined requestor node,
the processor further configured to execute operations comprising:
determining whether the region to which the predetermined requestor node belongs is different from the predetermined region based on the identification information, and
the selecting further comprises selecting the requestor node except when the region to which the predetermined requestor node belongs is different from the predetermined region and the predetermined value has been reached.

3. The information processing device according to claim 1, wherein the predetermined value is smaller than an average value of a number of selected nodes belonging to a region different from the predetermined region in a case where the selecting selects the Inbound adjacent node substantially at random.

4. The information processing device according to claim 1, wherein
the selecting further comprises selecting a predetermined possible node as an Outbound adjacent node, and
the selecting further comprises selecting the predetermined possible node as an Outbound adjacent node except when a region to which the predetermined possible node belongs is different from the predetermined region and a predetermined value of nodes belonging to a region that is different from the predetermined region that is selectable as Outbound adjacent nodes has been reached.

5. The information processing device according to claim 4, wherein an upper limit value selectable as Inbound adjacent nodes is the same as an upper limit value selectable as Outbound adjacent nodes, and a predetermined value of nodes belonging to a region different form the predetermined region that is selectable as Inbound adjacent nodes is the same as a predetermined value of nodes belonging to a region different from the predetermined region that is selectable as Outbound adjacent nodes.

6. An information processing device comprising a processor configured to execute operations comprising:
except when a region to which the predetermined requestor node belongs is different from a predetermined region to which the information processing device belongs and a ratio of nodes belonging to a region different from the predetermined region that can be selected as Inbound adjacent nodes at an upper limit value selectable as Inbound adjacent nodes has reached a predetermined value:
selecting, by the predetermined node among a plurality of nodes of a blockchain network, a requestor node that has made a request for adding an Inbound adjacent node as an Inbound adjacent node, wherein the blockchain network extends over a plurality of regions; and
receiving, by the predetermined node, the request for adding an Inbound adjacent node from a predetermined requestor node.

7. A computer implemented method for selecting a node, comprising:
except when a region to which a predetermined requestor node belongs is distinct from a predetermined region to which the predetermined node belongs and a predetermined value of nodes belonging to a region is different from the predetermined region that is selectable as Inbound adjacent nodes has been reached:
receiving, by the predetermined node among a plurality of nodes of a blockchain network, a request for adding an Inbound adjacent node from a predetermined requestor node, wherein the blockchain network extends over a plurality of regions; and
except when a region to which the predetermined requestor node belongs is different from a predetermined region to which the information processing device belongs and a predetermined value of nodes belonging to a region different from the predetermined region that can be selected as Inbound adjacent nodes has been reached, selecting the requestor node as an Inbound adjacent node.

8. A computer-readable non-transitory recording medium storing a computer-executable program instructions that when executed by a processor cause a computer system to execute the method according to claim 7.

9. The information processing device according to claim 1, wherein the processor executes as the predetermined node.

10. The information processing device according to claim 6, wherein the processor executes as the predetermined node.
